(19) United States
(12) Patent Application Publication
(10) Pub. No.: US 2004/0258985 A1
(43) Pub. Date: Dec. 23, 2004

(54) Battery having electrical connection stabilizing means and battery assembly using same

(76) Inventor: Kun-June Tsai, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/873,866

(22) Filed: Jun. 21, 2004

(30) Foreign Application Priority Data
Jun. 20, 2003 (TW) 92211310

(51) Int. Cl. H01M 2/00; H01M 2/20; H01M 2/02; H01M 6/42

(52) U.S. Cl. 429/157; 429/158; 429/1; 429/164

(57) ABSTRACT

A battery (6) includes a first end (61) and an opposite second end (63). A first mechanical connecting member (611) and a second mechanical connecting member (631) are provided on the first and second ends respectively. The first mechanical connecting member is engagable with the second mechanical connecting member of another similar battery. The second mechanical connecting member is engagable with the first mechanical connecting member of another similar battery. Thus the battery provides stabilized electrical connection with another similar battery. Preferably, the first mechanical connecting member includes two protrusion, and the second mechanical connecting member includes two receptacle engagingly receiving the protrusions of another similar battery. Each protrusion may for example be cylindrical, conical, annular, or parallelepiped-shaped. The battery may for example be cylindrical, parallelepiped-shaped, or coin-shaped. A battery assembly (600) using two or more such batteries is also provided.

### BACKGROUND OF THE INVENTION

1. Field of the Invention

The present invention relates to a battery and a battery assembly comprising two or more batteries, and more particularly to a battery providing a stabilized electrical connection with each neighboring battery in a battery assembly.

2. Description of Prior Art

Conventional portable batteries are frequently aggregated together into a battery assembly in order to provide a higher voltage. As exemplified in FIG. 5, two batteries in a battery assembly 500 are generally electrically connected by means of direct contact between the negative electrode of one battery and the positive electrode of the other battery.

For instance, portable radios typically employ the battery assembly 500 to provide a higher voltage. A battery compartment of the radio has flexible metal terminals at opposite ends thereof, with the battery assembly 500 biasedly engaged between the terminals. The compartment is also configured to fittingly retain the battery assembly therein, so that relative movement between the two batteries is minimized. However, after repeated removal and installation of battery assemblies 500, the terminals are liable to become fatigued and weak. The batteries are then prone to move within the compartment and disrupt electrical connections therein.

### SUMMARY OF THE INVENTION

In view of the above-described shortcomings, an object of the present invention is to provide a battery yielding stabilized electrical connections when used in a battery assembly.

Another object of the present invention is to provide a battery assembly having batteries with stabilized electrical connections.

In one aspect of the present invention, there is provided a battery comprising a first end and an opposite second end. A first mechanical connecting member and a second mechanical connecting member are provided on the first and second ends respectively. The first mechanical connecting member is engagable with the second mechanical connecting member of another similar battery. The second mechanical connecting member is engagable with the first mechanical connecting member of another similar battery. Thus the battery provides stabilized electrical connection with one or more other similar batteries.

In another aspect of the present invention, there is provided a battery assembly comprising at least two batteries arranged end-to-end. Each two neighboring batteries are electronically connected to each other. Each battery comprises a first end and an opposite second end. At least one first mechanical connecting member and at least one second mechanical connecting member are provided on two adjoining ends of each two neighboring batteries respectively. The first mechanical connecting member of one such battery engages with the second mechanical connecting member of the other such battery, so that electrical connection between the two neighboring batteries is stabilized.

Preferably, the first mechanical connecting member comprises at least one protrusion, and the second mechanical connecting member comprises at least one receptacle engagingly receiving the at least one protrusion of another similar batteries. The at least one protrusion may for example be cylindrical, conical, annular, or parallelepiped-shaped. The battery may for example be cylindrical, parallelepiped-shaped, or coin-shaped.

In summary, mechanical connecting members are provided on the batteries of the prevent invention. As a result, when the batteries are connected to each other, little or no relative movement therebetween can occur. Thus stabilized electrical connections between each two neighboring batteries is attained.

These and other features, aspects and advantages of the invention will become more apparent from the following detailed description and claims, and from the accompanying drawings.

### BRIEF DESCRIPTION OF THE DRAWINGS

FIG. 1 is an isometric view of a battery having electrical connection stabilizing means in accordance with a preferred embodiment of the present invention.

FIG. 2 is an isometric view of a battery assembly in accordance with the preferred embodiment of the present invention, the battery assembly comprising two batteries of the type shown in FIG. 1.

FIG. 3 is an isometric view of a battery in accordance with an alternative embodiment of the present invention.

FIG. 4 is an isometric view of another battery assembly in accordance with an alternative embodiment of the present invention, the battery assembly comprising two batteries of the type shown in FIG. 3.

FIG. 5 is an isometric view of a conventional battery assembly.

### DETAILED DESCRIPTION OF THE PREFERRED EMBODIMENTS OF THE PRESENT INVENTION

With reference to FIG. 1, there is shown a battery 6 having electrical connection stabilizing means in accordance with the preferred embodiment of the present invention. The battery 6 is cylindrical, and comprises a first end 61 and an opposite second end 63.

The first end 61 is provided with a pair of first protrusions 611 and a second protrusion 612. Each first protrusion 611 is cylindrical, and is fixed on the first end 61 by soldering or gluing. The first protrusion 611 may alternatively be conical, annular, parallelepiped-shaped, or another suitable shape. Further, the first protrusion 611 may alternatively be integrally formed with the first end 61. The second protrusion 612 is a positive electrode of the battery 6.

The second end 63 has a surface adapted to function as a negative electrode of the battery 6. The second end 63 is provided with a first receptacle 631 and a second receptacle 632. The first and second receptacles 631, 632 are configured to correspond to the first and second protrusions 611, 612, respectively. Therefore, the first and second receptacles 631, 632 of one battery 6 can engagingly receive the first and second protrusions 611, 612 of another battery 6.

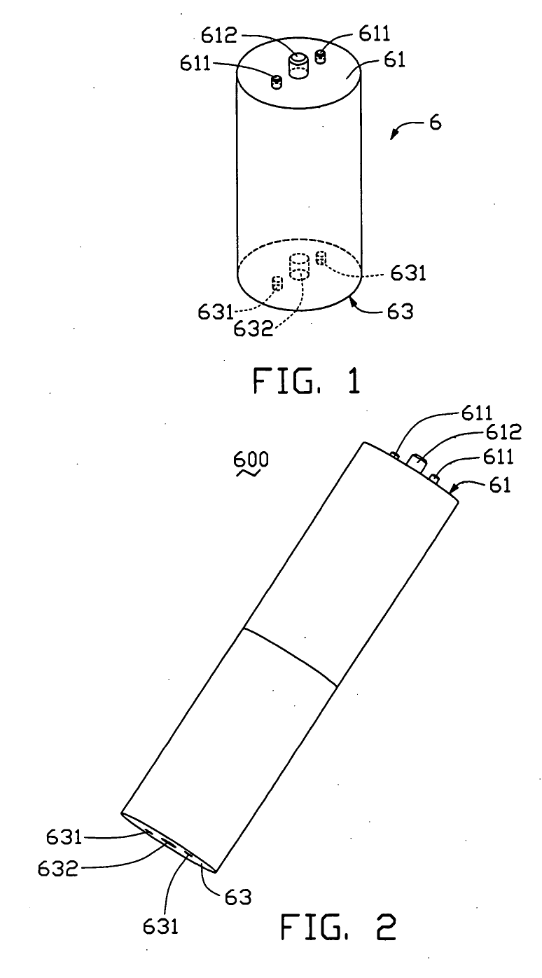

As shown in FIG. 2, a battery assembly 600 comprises two batteries 6 connected end-to-end. The first and second protrusions 611, 612 of one battery 6 are engaged in the first and second receptacles 631, 632 of the other battery 6. The two batteries 6 are thus electrically connected to form the battery assembly 600.

Referring to FIG. 3, a battery 7 according to an alternative embodiment of the present invention comprises a first end 71 and an opposite second end 73. The first end 71 is provided with two first protrusions 711 and a second protrusion 712. Each first protrusion 711 comprises a receptacle 7110. The second protrusion 712 is a positive electrode of the battery 7.

The second end 73 is provided with two third protrusions 731. The third protrusions 731 are configured to correspond to the receptacles 7110 of the first protrusions 711. Therefore, the third protrusions 731 of one battery 7 can engage in the receptacles 7110 of another battery 7.

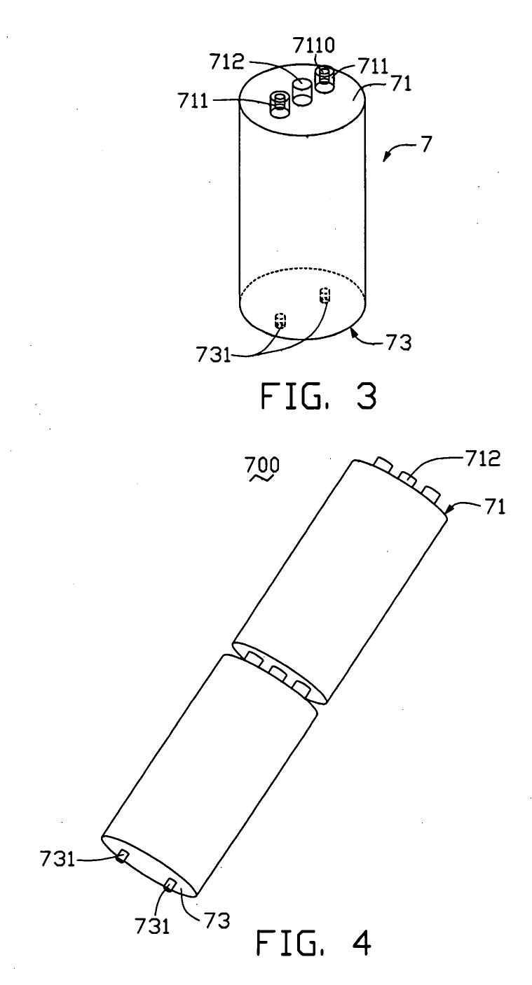

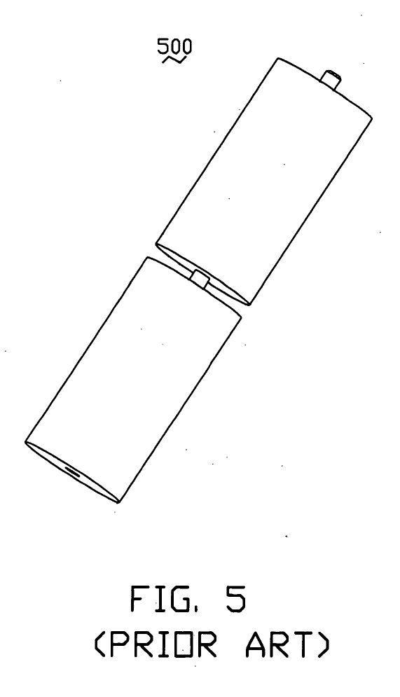

As shown in FIG. 4, a battery assembly 700 comprises two batteries 7 connected end-to-end. The receptacles 7110 of one battery 7 engagingly receive the third protrusions 731 of the other battery 7. The two batteries 7 are thus electrically connected to form the battery assembly 700.

In summary, mechanical connecting members are provided on the batteries of the prevent invention. As a result, when the batteries are connected to each other, little or no relative movement therebetween can occur. Thus stabilized electrical connections between each two neighboring batteries is attained.

It should be noted that the above-described batteries have been provided for the purposes of illustrating the present invention. The particular batteries described are not critical to practicing the present invention. Various kinds of batteries known to those skilled in the art, such as parallelepiped-shaped batteries and coin batteries, may be suitably adapted for practicing the present invention. Each battery in a battery assembly may have at least one protrusion and at least one receptacle. The protrusions and receptacles may be arranged together on the same first or second end of each battery, or on the same first end and on the same second end of each battery. The batteries and battery assemblies exemplified herein are for illustration purposes only, and are not intended to limit the present invention.

Further, in general, while the present invention has been described with reference to particular embodiments, the description is illustrative of the invention and is not to be construed as limiting the invention. Therefore, various modifications can be made to the preferred embodiments by those skilled in the art without departing from the true spirit and scope of the invention as defined by the appended claims.

What is claimed is:

1. A battery comprising:
a first end;
an opposite second end; and
a first mechanical connecting member and a second mechanical connecting member provided on the first and second ends respectively, the first mechanical connecting member being engagable with the second mechanical connecting member of another similar battery, the second mechanical connecting member being engagable with the first mechanical connecting member of another similar battery, whereby the battery provides stabilized electrical connection with another similar battery.

2. The battery as recited in claim 1, wherein the first mechanical connecting member comprises at least one protrusion, and the second mechanical connecting member comprises at least one receptacle for engagingly receiving the at least one protrusion of another similar battery.

3. The battery as recited in claim 2, wherein the at least one protrusion is cylindrical, conical, annular, or parallelepiped-shaped.

4. The battery as recited in claim 1, wherein the battery is cylindrical, parallelepiped-shaped, or coin-shaped.

5. The battery as recited in claim 1, wherein the battery comprises a positive electrode and a negative electrode provided on the first and second ends respectively.

6. A battery assembly comprising:
at least two batteries, each two neighboring batteries electrically connecting with each other, and each battery comprising a first end and an opposite second end; and
at least one first mechanical connecting member and at least one second mechanical connecting member provided on two adjoining ends of each two neighboring batteries respectively, the at least one first mechanical connecting member of one such battery engaging with the at least one second mechanical connecting member of the other such battery, whereby electrical connection between the two neighboring batteries is stabilized.

7. The battery assembly as recited in claim 6, wherein the at least one first mechanical connecting member comprises a protrusion, and the at least one second mechanical connecting member comprises a receptacle engagingly receiving the protrusion.

8. The battery assembly as recited in claim 7, wherein the protrusion is cylindrical, conical, annular, or parallelepiped-shaped

9. The battery assembly as recited in claim 6, wherein each battery is cylindrical, parallelepiped-shaped, or coin-shaped.

10. The battery assembly as recited in claim 6, wherein each battery comprises a positive electrode and a negative electrode provided on the first and second ends respectively.

11. A battery assembly comprising:
at least two identical batteries stacked with each other, each of said batteries including:
negative and positive electrodes respectively disposed on two opposite end faces in a lengthwise direction, and
first and second coupling devices respectively disposed on said two opposite end faces; wherein
said first and second coupling devices are dimensioned and configured to retainably engage each other so as to allow said at least two batteries to be assembled as one unit along said lengthwise direction under a condition that the positive electrode of one of said two batteries is connected to a negative electrode of the other and a voltage of said combined unit is a sum of the voltages of both said two batteries.

12. The batteries as recited in claim 11, wherein said first and second coupling devices prevent relative rotation between the two batteries about said lengthwise direction.
